(19) United States
(12) Patent Application Publication
(10) Pub. No.: US 2008/0154542 A1
(43) Pub. Date: Jun. 26, 2008

(54) Method And Apparatus For Determining The Confidence Index Of The Estimated Location For A Target Device In A Wireless System

(76) Inventors: Ming-Chun Hsyu, Taichung (TW); Wen Tsuei, Hsinchu (TW); Chao-Nan Chen, Taichung (TW)

Correspondence Address: LIN & ASSOCIATES INTELLECTUAL PROPERTY, INC., P.O. BOX 2339, SARATOGA, CA, 95070-0339, US

(21) Appl. No.: 11/737,756

(22) Filed: Apr. 20, 2007

(30) Foreign Application Priority Data
Dec. 22, 2006 (TW) 095148633

(51) Int. Cl. G06F 17/18

(52) U.S. Cl. 702/181

(57) ABSTRACT

Disclosed is a method for determining the confidence index of the estimated position for a target device in a wireless system. In the online location determining phase, after knowing the observations of the radio signal for a target device, the target device's probability distribution of location and its motion model are combined to calculate the position uncertainty, thereby giving the confidence index of this location estimate. The invention determines the location probability distribution, and calculates the uncertainty of the location probability distribution and the possible maximum uncertainty under the current situation. Based on these uncertainties, this invention determines the confidence index of the radio signal. The confidence may be regarded as a quantity that the location uncertainty can be excluded in the location prediction. The larger the quantity is, the more confident the estimated location is.

### FIELD OF THE INVENTION

The present invention generally relates to a method and an apparatus for determining confidence index of the location determination for a target device in a wireless system.

### BACKGROUND OF THE INVENTION

The wireless location determination system is widely applied to many systems, including location-sensitive content delivery, direction finding, asset tracking, emergency notification, and so on. To estimate the location of a target device, a location determining system must measure a quantity, which is at least a function of distance. This quantity can be the strength of signals transmitted from the access points (APs). In a free space, the signal strength will logarithmically decay with distance.

The wireless location determining system usually uses two phases for processing. One is a training phase, and the other is a location determining phase. The training phase is an offline phase, in which the system establishes the sample points (SP) and a map, known as a radio map, and captures the AP signatures at certain points of the coverage region. In the location determining phase, the signal strength vector from APs is compared to the radio map to find an optimal match, such as the nearest candidate, as the estimated location of the target device. There are many methods to estimate location and determine the estimation error.

U.S. Patent Publication No. 2005/0131635 disclosed a method for determining the error distance of the predicted location of a target device. This method is based on a probabilistic model 101 and the collected observations of signal value 103 to determine the location of the target device, as shown in FIG. 1. The probabilistic model 101 shows the signal value probability distribution of a plurality of APs. The error estimate is determined by the expectation of the error distance between the actual location of the target device TD and the estimated location EL. The error distance estimation can be used to determine whether to add new SPs, or recalibrate the existing SPs.

The above method depends on the location decision rule. Therefore, there is potential problem of improper decision rule or interference.

### SUMMARY OF THE INVENTION

The examples of the present invention may provide a method for determining the confidence index of the estimated location for a target device in a wireless system, and an apparatus for implementing the method. In location determining, the motion model and the location probability distribution of the target device can be used to calculate the uncertainty of the estimated location, and further to calculate the confidence index of the estimated location.

After the observations of signals of the target device are received, the uncertainty of location probability distribution of the target device can be used to calculate the confidence index. In calculating the probability distribution, the transition probability distribution of the target device moving from a location to another location is also taken into account. The meaning of the confidence index is a quantity to exclude the uncertainty of the location of the target device. The more the uncertainty is excluded, the higher the confidence index of the estimated location is.

The method for determining the confidence index of the present invention may include the following steps. First, a location probability density function is determined. The location probability density function is a conditional density function p(qₜ|oₜ,qₜ₋₁), where oₜ is the current received radio signal of the target device, and qₜ₋₁ is the previous location of the target device. Then, the uncertainty of the location probability density function is calculated, and the maximum uncertainty in the current situation is also calculated. Finally, the confidence index of the radio signal oₜ is calculated.

For implementing the method, an apparatus may include a location probability model, a module for calculating the uncertainty of the location probability density function p(qₜ|oₜ,qₜ₋₁) and the maximum uncertainty in the current situation, and a confidence index module for calculating the confidence index.

### BRIEF DESCRIPTION OF THE DRAWINGS

FIG. 1 shows a conventional method for determining error distance of a predicted location for a target device.

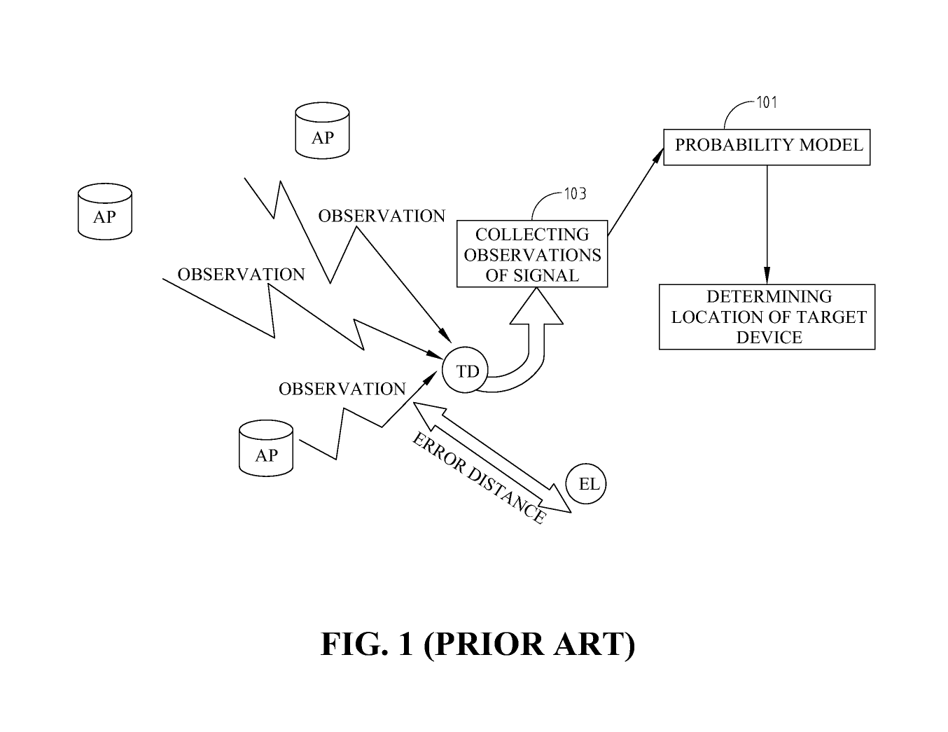

FIG. 2 shows a flowchart illustrating the operating flow for determining the confidence index of estimated location in a wireless system of the present invention.

FIG. 3 shows how a Hidden Markov Model (HMM) is applied to a location determining system.

FIG. 4 shows the four probability distribution functions corresponding to the radio signals received at four different locations.

FIG. 5a shows an example illustrating the transition probability of a target device moving to each sample point.

FIG. 5b shows the location probability density function of the target device based on FIG. 5a.

FIG. 5c shows a working example of the confidence index at each sample point based on FIG. 5a.

### DETAILED DESCRIPTION OF THE PREFERRED EMBODIMENTS

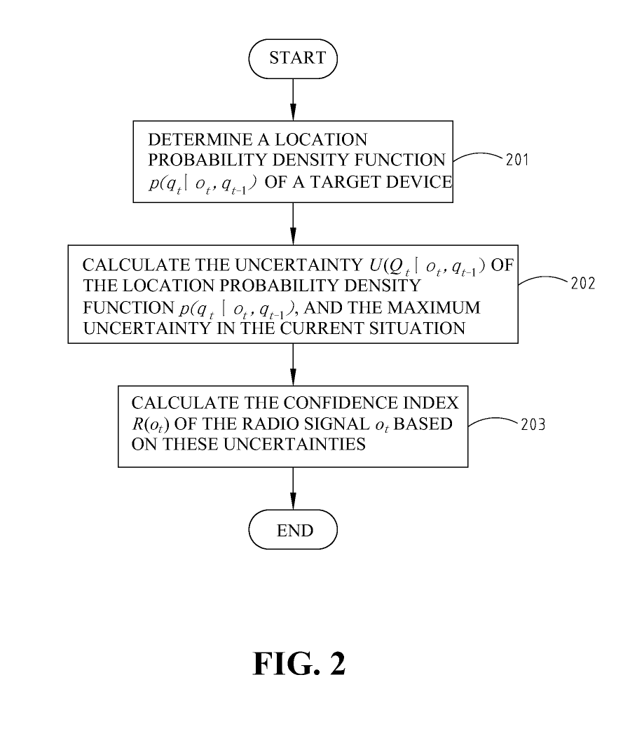

As aforementioned, wireless location determining systems usually process in two phases. One is the training phase, and the other is the location determining phase. The present invention computes the confidence index when the current received radio signal oₜ and the previous location qₜ₋₁ of the target device are available in the location determining phase. FIG. 2 shows a flowchart illustrating the operating flow for determining the confidence index of estimated location in a wireless system according to the present invention.

As shown in FIG. 2, the first step is to determine a location probability density function of a target device, as shown in step 201. There are many possible examples of the location probability density function. Without loss of generality, the following location probability density function uses posterior probability density function p(qₜ|oₜ,qₜ₋₁) for description.

The next step is to calculate the uncertainty U(Qₜ|oₜ,qₜ₋₁) of the location probability density function p(qₜ|oₜ,qₜ₋₁) , and the maximum uncertainty in the current situation, as shown in step 202. Step 203 is to calculate the confidence index R(oₜ) of the radio signal oₜ based on these uncertainties. The following describes the detailed operations of steps 201-203.

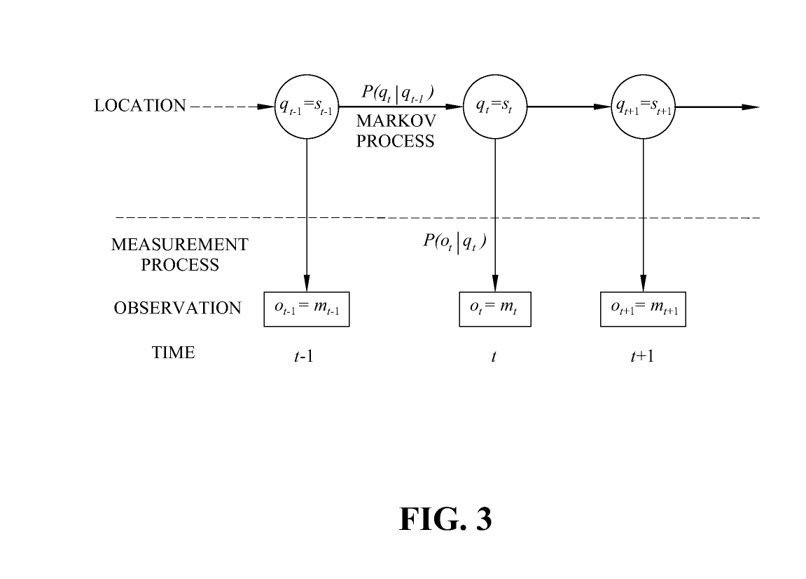

In step 201, the location probability density function is a conditional probability density function p(qₜ|oₜ,qₜ₋₁), where oₜ is the current received radio signal, and qₜ₋₁ is the previous location. The location probability density function p(qₜ|oₜ,qₜ₋₁) of the target device can be calculated by applying Hidden Markov Model (HMM) to the location tracking system. FIG. 3 shows how a Hidden Markov Model (HMM) is applied to a location determining system. As shown in FIG. 3, the HMM includes the transition probability between two locations and the probability of observation at a specified location. The location probability can be calculated from the transition probability between two locations and the probability of observation at a specified location.

When time changes from t−1 to t+1, the target device moves along three locations qₜ₋₁, qₜ, and qₜ₊₁. P(qₜ|qₜ₋₁) is the probability that the target device moves from qₜ₋₁ to qₜ during time t−1 to t+1. In the measurement process, the observations of the radio signal are reported. The observations are the quantity only related to the location at the corresponding time. Without loss of generality, the reported observation of location by the target device forms a probability distribution, and furthermore, of a conditional probability. In other words, condition probability P(oₜ=mₜ|qₜ=sₜ) is the probability that the observation is mₜ when the target device is at location sₜ.

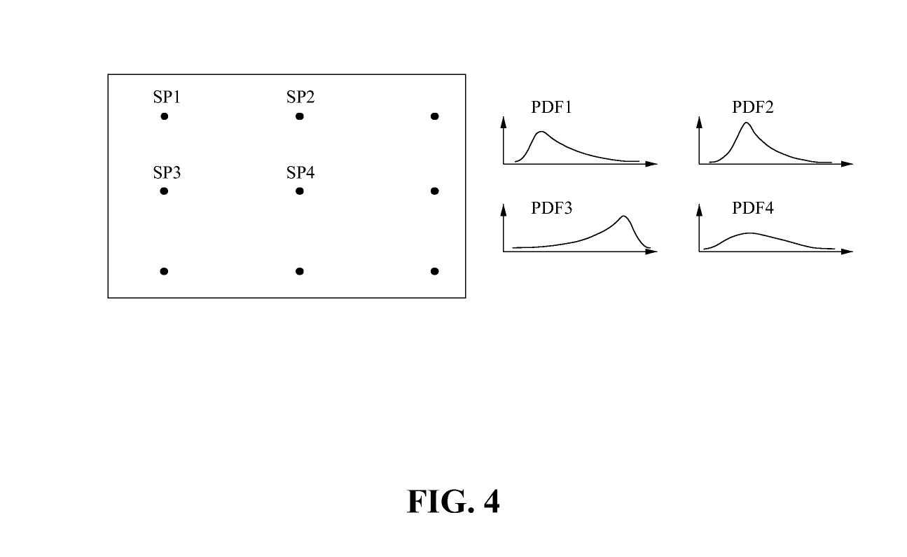

FIG. 4 shows the four probability distributions PDF1-PDF4 corresponding to the radio signals received at four different locations SP1-SP4. In general, the location-conditioned probabilities of observations can be viewed as independent of each other. That is, P(oₜ=mₜ, oₜ₋₁=m_{t -1}|qₜ=sₜ, qₜ₋₁=sₜ₋₁)=P(oₜ=mₜ|qₜ=sₜ) P(oₜ₋₁=mₜ₋₁|qₜ₋₁=sₜ₋₁). Furthermore, the current location of the target device can be viewed as only dependent on the last location. That is, the transition model of two locations follows the Markov P(qₜ=sₜ|qₜ₋₁=sₜ₋₁qₜ₋₁=s_{t-2, . . . q}₀=s₀)=P(qₜ=sₜ|qₜ₋₁=s_{t-1).}

Because it is impossible to directly obtain the locations qₜ₋₁, qₜ, and qₜ₊₁ of the target device, the present invention uses a series of observations o_{t-1, o}ₜ, and oₜ₊₁ to estimate the location of the target device.

Therefore, the location probability density function p(qₜ|oₜ, qₜ₋₁) can be obtained from the following equation:

$$p ( {q}_{t} \text{\textbar} {o}_{t} , {q}_{t - 1} ) = \frac{p ( {q}_{t} , {o}_{t} \text{\textbar} {q}_{t - 1} )}{p ( {o}_{t} \text{\textbar} {q}_{t - 1} )} .$$

Because the observation only depends on the current location of the target device, the numerator p(qₜ, oₜ|qₜ₋₁) of location probability density function p(qₜ|oₜ,qₜ₋₁) can be expressed as the following equation:

p(qₜ,oₜ|qₜ₋₁)=p(oₜ|qₜ,qₜ₋₁)p(qₜ|qₜ₋₁)=p(oₜ|qₜ)p(qₜ|qₜ₋₁).

According to the Bayes' theorem, the denominator p(oₜ|qₜ₋₁) of location probability density function p(qₜ|oₜ,qₜ₋₁) can be obtained from the following equation:

$${\sum }_{{\tilde{q}}_{t} ∈ {Q}_{t}} p ( {o}_{t} \text{\textbar} {\tilde{q}}_{t} ) p ( {\tilde{q}}_{t} \text{\textbar} {q}_{t - 1} )$$

where p(\tilde{q}ₜ|qₜ₋₁) is the transition probability that the target device moves from location qₜ₋₁ at previous time t−1 to possible location \tilde{q}ₜ at current time t. The transition probability follows HMM.

The motion model and the location probability distribution of the target device can be used to calculate the uncertainty of the estimated location.

In step 202, the uncertainty U(Qₜ|oₜ, qₜ₋₁) of location probability density function p(qₜ|oₜ,qₜ₋₁) can be the self-contained information function of location probability density function p(qₜ|oₜ, qₜ₋₁), such as the average. Uncertainty U(Qₜ|oₜ, qₜ₋₁) can be calculated by the following equation:

$$\begin{matrix}U ( {Q}_{t} \text{\textbar} {o}_{t} , {q}_{t - 1} ) = H ( {Q}_{t} \text{\textbar} {o}_{t} , {q}_{t - 1} ) \\ = - {\sum }_{{q}_{t} ∈ {Q}_{t}} p ( {q}_{t} \text{\textbar} {o}_{t} , {q}_{t - 1} ) {log}_{2} p ( {q}_{t} \text{\textbar} {o}_{t} , {q}_{t - 1} ) .\end{matrix}$$

where Qₜ is all possible locations of the target device at time t,
oₜ is the specific observation received by the target device at time t,
p(qₜ|oₜ,qₜ₋₁) is the probability that the target device's location is qₜ at time t,
given that oₜ is received and the estimated location of target device at time t−1 is qₜ₋₁, and
H(Qₜ|oₜ,qₜ₋₁) is the entropy of the location probability distribution p(q₁|oₜ,qₜ₋₁).

It is worth noting that H(Qₜ|oₜ,qₜ₋₁) can be expressed as the following equation:

$$H ( {Q}_{t} \text{\textbar} {o}_{t} , {q}_{t - 1} ) = {\sum }_{{q}_{t} ∈ {Q}_{t}} \frac{p ( {q}_{t} , {o}_{t} \text{\textbar} {q}_{t - 1} )}{p ( {o}_{t} \text{\textbar} {q}_{t - 1} )} {log}_{2} \frac{p ( {o}_{t} \text{\textbar} {q}_{t - 1} )}{p ( {q}_{t} , {o}_{t} \text{\textbar} {q}_{t - 1} )} , \\ where$$

$$p ( {o}_{t} \text{\textbar} {q}_{t - 1} ) = {\sum }_{{\tilde{q}}_{t} ∈ {Q}_{t}} p ( {o}_{t} \text{\textbar} {\tilde{q}}_{t} ) p ( {\tilde{q}}_{t} \text{\textbar} {q}_{t - 1} ) , and$$

$$p ( {q}_{t} , {o}_{t} \text{\textbar} {q}_{t - 1} ) = p ( {o}_{t} \text{\textbar} {q}_{t} ) p ( {q}_{t} \text{\textbar} {q}_{t - 1} ) .$$

The maximum entropy of the all possible probability distributions occurs when the probabilities of possible locations are the same under the same condition, and the maximum entropy is log₂(|Qₜ|), where |Qₜ| is the total number of all possible locations at time t.

According to the meaning of the information entropy, the larger the entropy is, the more uncertainty the estimated location has. In other words, the predication is less reliable. Therefore, the confidence index can be viewed as the quantity to exclude the uncertainty of the estimated location of the target device in the prediction. The more uncertainty the quantity can exclude, the higher the confidence index of the estimated location is.

The present invention defines the confidence index of the estimated location of the target device as the functions of two variables. One is the current location of the target device, and the other is the maximum entropy of all possible probability distributions under the same condition. Therefore, in step 203, the confidence index of the present invention depends on the quantity of location uncertainty of the target device that can be excluded from the location prediction of the target device. An example of the definition of the confidence index R(oₜ) is as follows:

$$R ( {o}_{t} ) = \sqrt{1 - \frac{H ( {Q}_{t} \text{\textbar} {o}_{t} , {q}_{t - 1} )}{{log}_{2} ( \vert {Q}_{t} \vert )}} \times 100 \% ,$$

where |Qₜ| is the total number of all possible locations at time t, and log₂(|Qₜ|) is the maximum entropy of all possible probability distributions under the same condition.

It is worth noting that the probability distribution that has the maximum entropy among all possible probability distributions indicates that the estimated location may be randomly selected, and the confidence index R(oₜ) will be 0%. If the received observation of radio signal is known, and the probability that the target device is in a certain grid/sample point is 1, the confidence index R(oₜ) will be 100%.

For implementing the method with the operating flow as shown in FIG. 2, an apparatus may include a location probability model, a module for calculating the uncertainty U(Qₜ|oₜ, qₜ₋₁) of the location probability density function p(qₜ|oₜ,qₜ₋₁) and the maximum uncertainty in the current situation, and a confidence index module for calculating the confidence index R(oₜ). The term of location probability model refers to a model that indicates a location probability density function for a target device in the wireless system, when a radio signal of the target device is known.

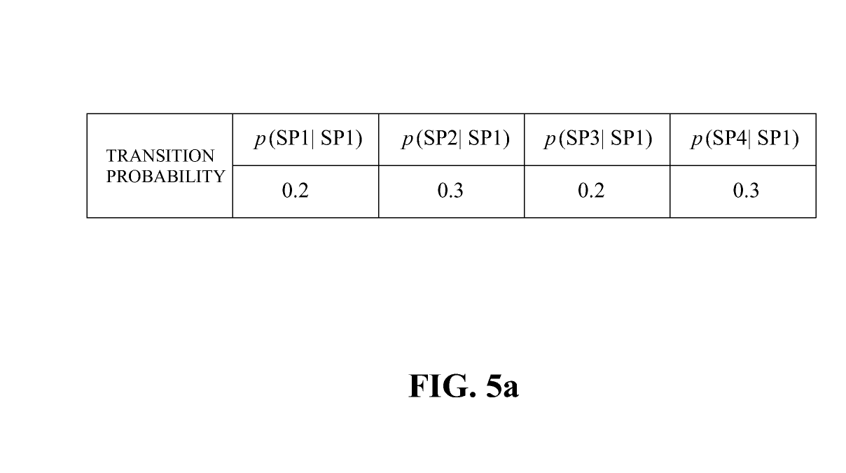

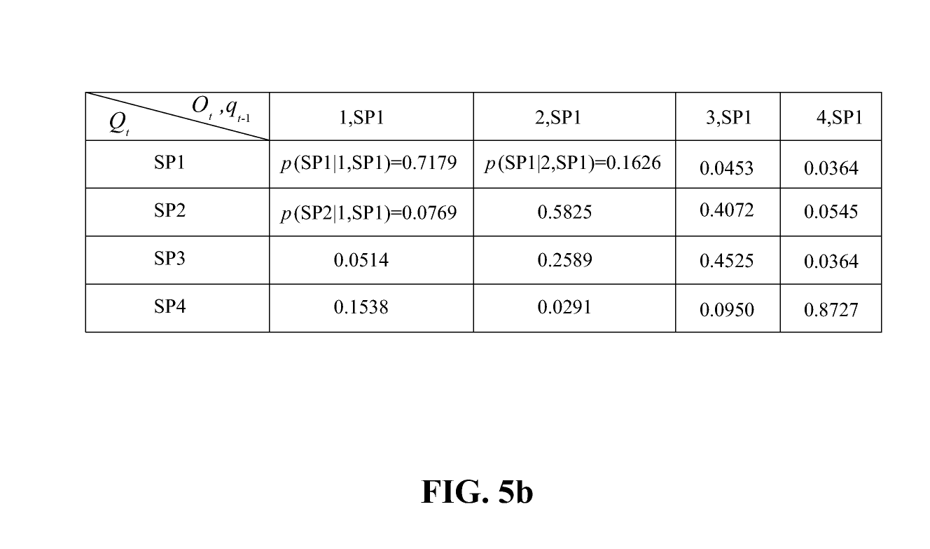

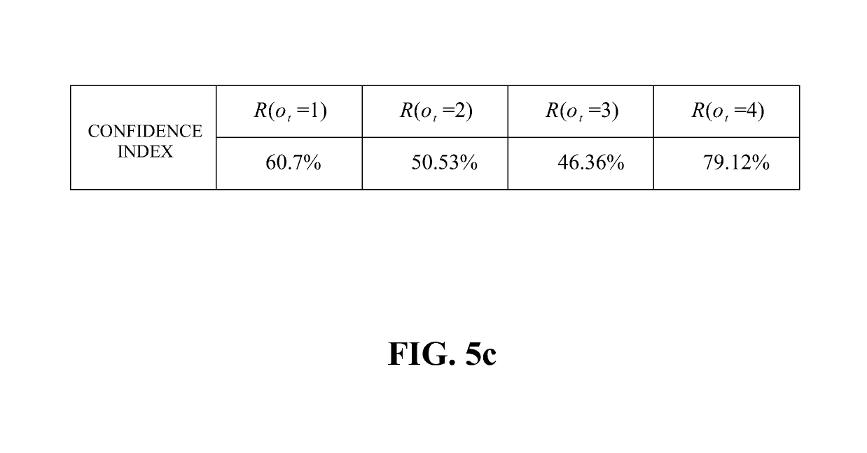

The following uses the four locations, SP1-SP4, as an example to describe how the uncertainty measurement is applied to the confidence index of estimated location. The known environment and the initial conditions of the wireless location determining system include the following: (a) received a radio signal, (b) the previous location of target device is SP1, i.e., qₜ₋₁=SP1, and the transition probability of the target device moving from SP1 to each SP is shown in FIG. 5a. In FIG. 5a, symbol Oₜ represents the signal received by the target device at time t, and the signals received at four sample points are indicated by 1, 2, 3, and 4.

According to step 201 of FIG. 2 and the aforementioned description, the determined location probability density function of the target device is p(qₜ|oₜ,qₜ₋₁), as shown in FIG. 5b. Finally, based on the example of the confidence index

$$R ( {o}_{t} ) = \sqrt{1 - \frac{H ( {Q}_{t} \text{\textbar} {o}_{t} , {q}_{t - 1} )}{{log}_{2} ( \vert {Q}_{t} \vert )}} \times 100 \% ,$$

the confidence index R(oₜ) at each SP can be obtained, as shown in FIG. 5c.

The results of FIG. 5c show that the lowest confidence index is 46.36% when received observation oₜ is 3. In other words, the most unreliable observation is signal 3, and the reason is that the inherited probability distribution of the observation at SP3 has a greater variance.

In summary, during the location determining, when the present invention receives the radio signal of a target device, the present invention can determine the uncertainty of the estimated location based on the motion model and the location probability distribution of the target device, and further obtains the confidence index of the estimated location. The confidence index depends on the location uncertainty that can be excluded from the estimated location. The flatter the posterior location probability distribution is, the higher the confidence index is.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for determining confidence index of estimated location of a target device in a wireless system, when a radio signal of said target device being known, said method comprising the steps of:
determining a location probability density function of said target device;
calculating a first uncertainty and a possible maximum uncertainty under current condition of said location probability density function; and
calculating a confidence index of said radio signal based on said first uncertainty and said maximum uncertainty.

2. The method as claimed in claim 1, wherein said location probability density function is a conditional probability density function p(qₜ|oₜ,qₜ₋₁), where oₜ is the current received radio signal at current time t, and qₜ₋₁ is the previous location.

3. The method as claimed in claim 1, wherein said confidence index is a function of said first uncertainty and said possible maximum uncertainty.

4. The method as claimed in claim 2, wherein said first uncertainty U(Qₜ|oₜ, qₜ₋₁) is a self-contained information function of said location probability density function.

5. The method as claimed in claim 2, wherein said first uncertainty U(Qₜ|oₜ, qₜ₋₁) is the average of self-contained information of said location probability density function.

6. The method as claimed in claim 4, wherein said first uncertainty U(Qₜ|oₜ, qₜ₋₁) is obtained through the following expression:
$$\begin{matrix}U ( {Q}_{t} \text{\textbar} {o}_{t} , {q}_{t - 1} ) = H ( {Q}_{t} \text{\textbar} {o}_{t} , {q}_{t - 1} ) \\ = - {\sum }_{{q}_{t} ∈ {Q}_{t}} p ( {q}_{t} \text{\textbar} {o}_{t} , {q}_{t - 1} ) {log}_{2} p ( {q}_{t} \text{\textbar} {o}_{t} , {q}_{t - 1} ) ,\end{matrix}$$
where Qₜ is all possible locations of said target device at time t;
oₜ is a specific observation received by said target device at time t;
p(qₜ|oₜ,qₜ₋₁) is the probability that said target device is at location qₜ at time t,
given that oₜ is received and the estimated location of said target device at time t−1 is qₜ₋₁;
log₂p(qₜ|oₜ,qₜ₋₁) is the self-contained quantity of the event that said target device is at location qₜ at time t, given that oₜ is received and the estimated location of said target device at time t−1 is qₜ₋₁; and
H(Qₜ|oₜ,qₜ₋₁) is the entropy of said location probability distribution p(qₜ|oₜ,qₜ₋₁).

7. The method as claimed in claim 2, wherein said conditional probability density function
$$p ( {q}_{t} \text{\textbar} {o}_{t} , {q}_{t - 1} ) = \frac{p ( {q}_{t} , {o}_{t} \text{\textbar} {q}_{t - 1} )}{p ( {o}_{t} \text{\textbar} {q}_{t - 1} )} , and$$
$$p ( {o}_{t} \text{\textbar} {q}_{t - 1} ) = {\sum }_{{\tilde{q}}_{t} ∈ {Q}_{t}} p ( {o}_{t} \text{\textbar} {\tilde{q}}_{t} ) p ( {\tilde{q}}_{t} \text{\textbar} {q}_{t - 1} ) ,$$
where p(\tilde{q}ₜ|qₜ₋₁) is the transition probability that said target device moves from location qₜ₋₁ at previous time t−1 to a possible location \tilde{q}ₜ at current time t.

8. The method as claimed in claim 7, wherein said p(\tilde{q}ₜ|qₜ₋₁) is a transition probability that obeys Markov model, and
p(qₜ,oₜ|qₜ₋₁₎₌ₚ₍ₒₜ|qₜ,qₜ₋₁)p(qₜ|qₜ₋₁)=p(oₜ|qₜ)p(qₜ|qₜ₋₁).

9. The method as claimed in claim 1, wherein said maximum uncertainty occurs when the probabilities of possible locations are the same under the same condition, and said maximum uncertainty has a maximum entropy.

10. The method as claimed in claim 9, wherein said maximum entropy is log₂(|Qₜ|) where |Qₜ| is the total number of all possible locations at time t.

11. The method as claimed in claim 1, wherein said confidence index depends on the quantity of said uncertainty of estimated location of said target device that is excluded from the location prediction of said target device.

12. The method as claimed in claim 6, wherein said confidence index is a function of H(Qₜ|oₜ,qₜ₋₁) and log₂(|Qₜ|) , where |Qₜ| is the total number of all possible locations at time.

13. An apparatus for determining confidence index of estimated location of a target device in a wireless system, when a radio signal of said target device being known, said apparatus comprising:
a location probability model indicating a location probability density function for said target device in the wireless system;
a module for calculating a first uncertainty and a possible maximum uncertainty under current condition of said location probability density function; and
a confidence index module for calculating a confidence index of said radio signal based on said first uncertainty and said maximum uncertainty.

14. The apparatus as claimed in claim 13, wherein said confidence index module produces said confidence index that is a function of said first uncertainty and said possible maximum uncertainty.

15. The apparatus as claimed in claim 13, wherein said location probability density function is a conditional probability density function p(qₜ|oₜ,qₜ₋₁), where oₜ is the current received radio signal at current time t, and qₜ₋₁ is the previous location.

16. The apparatus as claimed in claim 13, wherein said first uncertainty U(Qₜ|oₜ, qₜ₋₁) is a self-contained information function of said location probability density function.

17. The apparatus as claimed in claim 13, wherein said possible maximum uncertainty has a maximum entropy, and said maximum entropy is log₂(|Qₜ|), where |Qₜ| is the total number of all possible locations at time t.
